(19) United States
(12) Patent Application Publication
(10) Pub. No.: US 2008/0178649 A1
(43) Pub. Date: Jul. 31, 2008

(54) Lock with indicator and multiple key-operable core

(76) Inventor: Chun Te Yu, Changhua County (TW)

Correspondence Address: BACON & THOMAS, PLLC, 625 SLATERS LANE, FOURTH FLOOR, ALEXANDRIA, VA, 22314, US

(21) Appl. No.: 12/076,983

(22) Filed: Mar. 26, 2008

Related U.S. Application Data
(63) Continuation-in-part of application No. 11/503,989, filed on Aug. 15, 2006.

(51) Int. Cl. E05B 67/00

(52) U.S. Cl. 70/38 R

(57) ABSTRACT

A lock includes a casing, a core and an indicator. The core is disposed in the casing and configured in such a way that a private key and a general key can be used to activate the core. The indicator is disposed in the casing and movable from a first position to a second position by the general key and movable from the second position back to the first position by the private key.

### CROSS REFERENCE TO RELATED APPLICATION

This application is a continuation-in-part of co-pending U.S. Application series No. 11/503,989 filed on Aug. 15, 2006.

### BACKGROUND OF THE INVENTION

1. Field of the Invention

The present invention relates to a lock and, more particularly, to a lock including a core operable by a private key and a general key and an indicator to indicate the application of the private key or the general key.

2. Description of the Prior Art

A conventional lock is provided with a crook under the control of a core. When the core is in a locking position, the crook is secured to a casing of the lock. When the core is in an un-locking position, the crook is freely movable relative to the casing. However, this conventional lock cannot indicate whether the core has been tampered with by an unauthorized person. In order to show who has accessed to the lock, U.S. Pat. Nos. 7,007,512 and 6,877,345 both provide mechanisms to indicate different statuses corresponding to different ways of assess to the core so that the user of the lock may have the information of who has accessed to the lock.

However, there is a disadvantage in the locks mentioned in the foregoing patents. That is, the user has to memorize the combination in order to activate the cores. Furthermore, the locks cannot indicate whether any unauthorized person has ever attempted to activate the core.

To overcome the shortcomings, the present invention is intended to provide an improved lock to mitigate the aforementioned problems.

### SUMMARY OF THE INVENTION

The primary objective of the present invention is to provide a lock including a core operable by a private key and a general key so that the user of the lock is no longer required to memorize the combination as used in a conventional dual lock.

Another objective of the present invention is to provide a lock with an indicator for showing whether the lock has been tampered with by an unauthorized person.

In order to accomplish the aforementioned objectives, a lock includes a casing, a core rotationally disposed in the casing, a crook-confining member firmly connected to the core to rotate simultaneously with the core and an indicator movably disposed in the casing between a first position where a private key is used and a second position where a general key is used. The indicator further includes a clasp stamped from a periphery of the indicator to be disposed in an aperture in the crook-confining member so that the clasp is disposed in the aperture of the crook-confining member to maintain the indicator in position after the indicator is moved upward to the second position.

Other objects, advantages and novel features of the invention will become more apparent from the following detailed description when taken in conjunction with the accompanying drawings.

### BRIEF DESCRIPTION OF DRAWINGS

FIG. 1 is a perspective view of a lock according to an embodiment of the present invention;

FIG. 2 is a perspective view of a private key used to activate a core of the lock shown in FIG. 1;

FIG. 3 is a perspective view of a general key used to activate the core of the lock shown in FIG. 2;

FIG. 4 is an exploded perspective view of the lock shown in FIG. 1;

FIG. 5 is another perspective view of the lock shown in FIG. 1, showing a keyhole;

FIG. 6 is a side view of the private key inserted in the lock shown in FIG. 2, showing that an extension from an indicator is free from the private key;

FIG. 7 is a side view of the general key inserted in the lock shown in FIG. 3, showing that the extension from the indicator is engaged with the general key;

FIG. 8 is a perspective view of the private key to activate the lock shown in FIG. 6;

FIG. 9 is a cross-sectional view of the lock shown in FIG. 8, showing that a clasp of the indicator is disposed in an aperture defined in a crook-confining member;

FIG. 10 is a side view of the indicator returned to its original position from the position shown in FIG. 9 because of a recoil force after the clasp is pushed from the aperture;

FIGS. 11, 12, 13A and 13B are cross-sectional views of cores according to various embodiments of the present invention;

FIG. 14 is a perspective view of a lock according to another embodiment of the present invention;

FIG. 15 is a perspective view of a lock according to another embodiment of the present invention;

FIG. 16 is a perspective view of a lock according to another embodiment of the present invention; and

FIG. 17 is a perspective view of a lock according to another embodiment of the present invention.

### DETAILED DESCRIPTION OF EMBODIMENTS

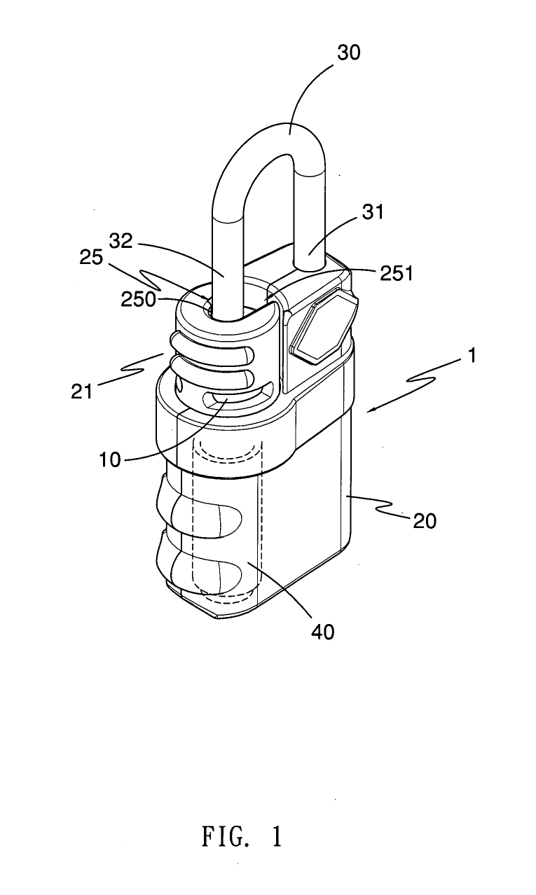

With reference to FIG. 1, in accordance with a first embodiment of the present invention, a lock includes a casing 20, a crook-confining member 21, a core 40, an indicator 10 and a crook 30. The core 40 is rotationally disposed in the casing 20. The indicator 10 is movably disposed in the casing 20. The crook-confining member 21 is firmly connected to the core 40 so that the crook-confining member 21 simultaneously rotates with the core 40. Furthermore, the crook-confining member 21 is rotationally mounted on the casing 20. The crook 30 is rotationally connected to the casing 20 and can be confined in and released from the crook-confining member 21.

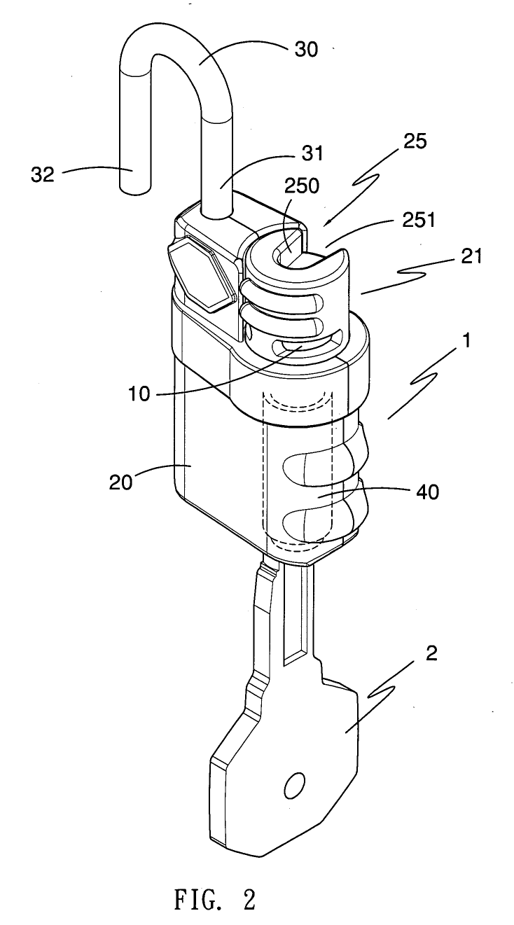

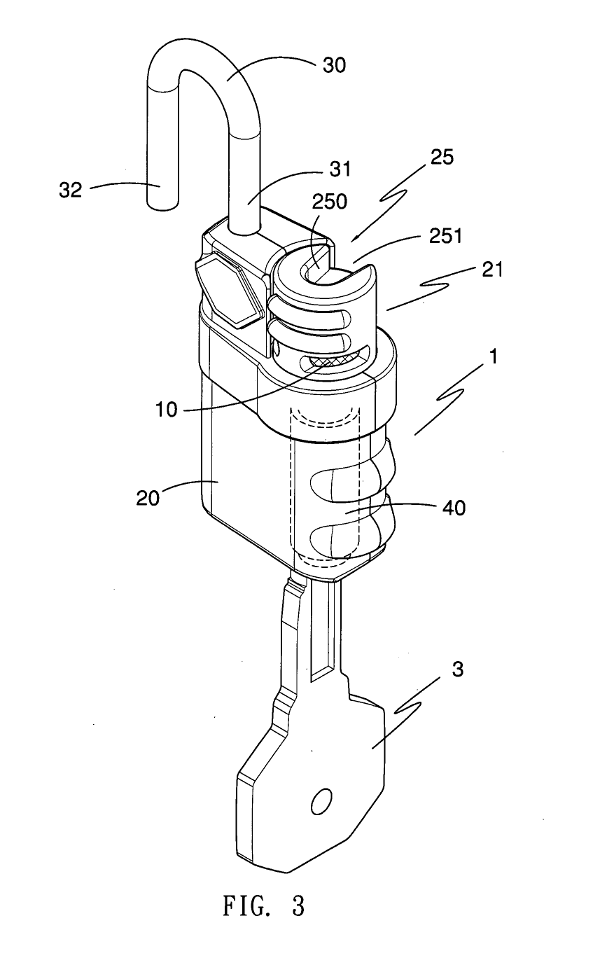

With reference to FIGS. 2 and 3, the core 40 is adapted for a private key 2 and a general key 3. That is, both the private key 2 and the general key 3 can be used to activate the core 40 to rotate the crook-confining member 21 to release the second end of the crook 30.

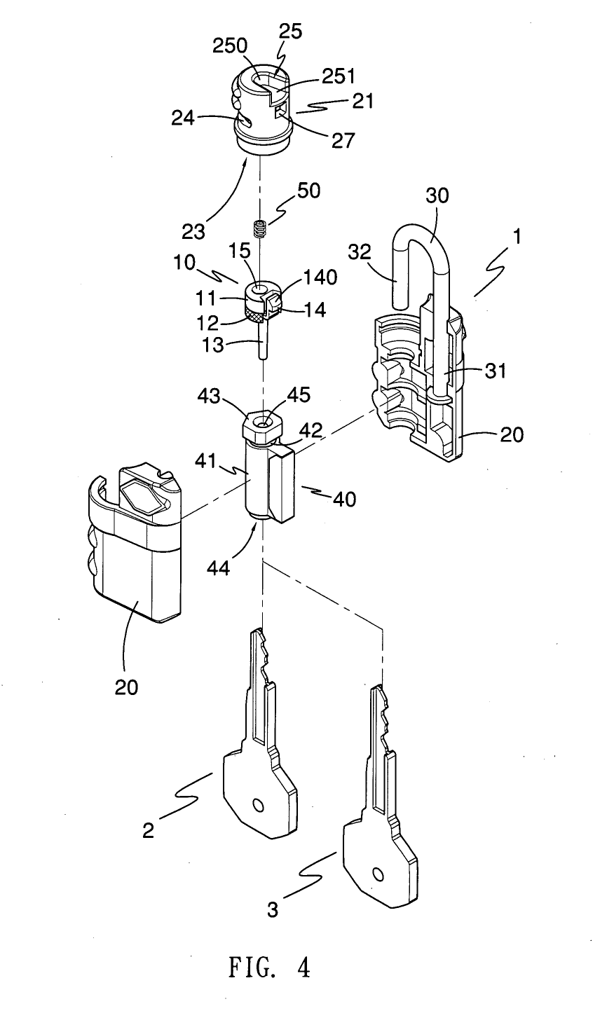

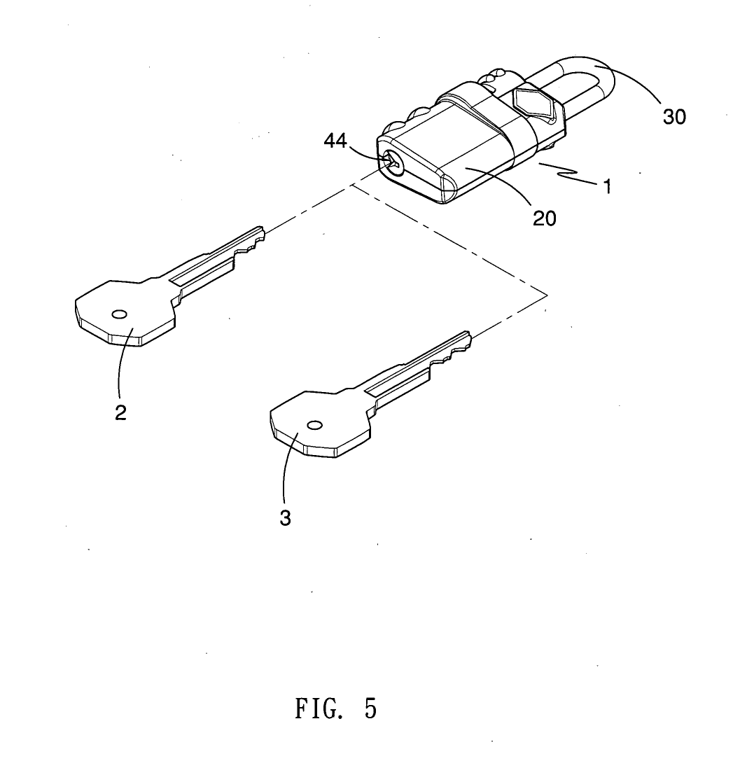

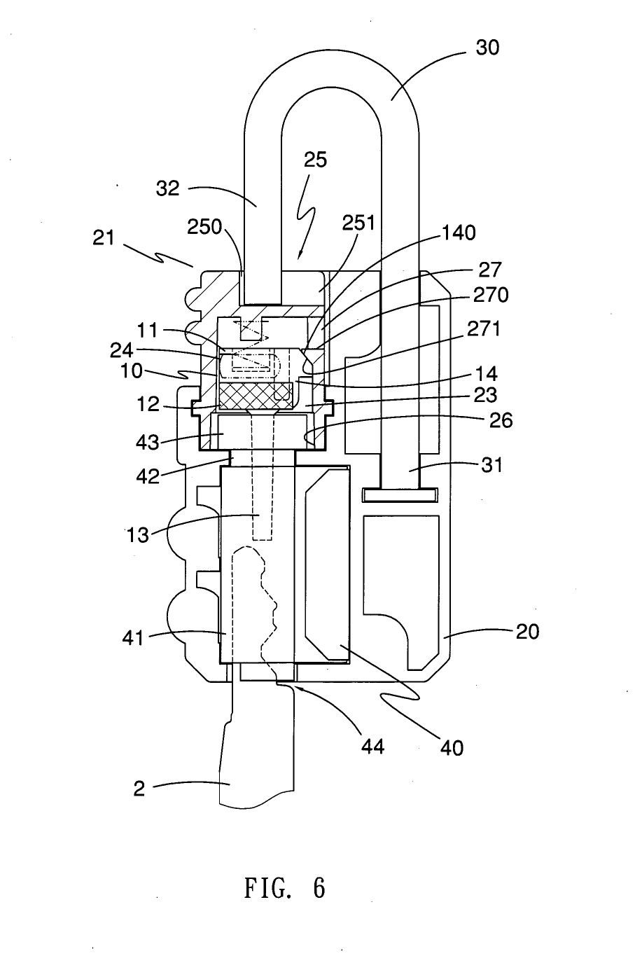

With reference to FIGS. 4 to 6, the indicator 10 includes a first zone 11, a second zone 12, an extension 13 and a clasp 14. The second zone 12 is formed together with the first zone 11. The extension 13 extends from a bottom face of the second zone 12. The clasp 14 is stamped out of an external side of the first zone 11. The clasp 14 includes a beveled face 140 on an upper face thereof. A recess 15 is defined in an upper face of the first zone 11 to receive a resilient element 50 such as a spring. The first zone 11 and the second zone 12 can be distinguished by different colors, such as red and green.

The crook-confining member 21 includes a compartment 23 defined in a lower portion thereof, a window 24 in communication with the compartment 23, a recess 25 defined in an upper face thereof, a space 26 in communication with the compartment 23 and an aperture 27 defined in an external side thereof. A guide pole 230 is extended from the ceiling of the compartment 23. The resilient element 50 is mounted around the guide pole 230. The recess 25 includes a first opening 250 centrally defined in an upper face of the crook-confining member 21 and a second opening 251 defined in a side of the crook-confining member 21. The first opening 250 is in communication with the second opening 251. The aperture 27 is in communication with the compartment 23. The aperture 27 is located lower than the recess 25. The aperture 27 receives the clasp 14 after the indicator 10 is moved upward relative to the casing 20. A boss 270 is formed on the wall of the compartment 23 and with a beveled face 271 corresponding to the beveled face 140 of the clasp 14 of the indicator 10.

The crook 30 includes a root 31 and a free end 32. The root 31 is rotationally disposed in the casing 20. The free end 32 can be confined in and released from the recess 25.

The core 40 includes a cylinder 41, a shaft 42, a head 43, a keyhole 44 and a tunnel 45. The cylinder 41 is securely disposed in the casing 20. The shaft 42 is rotationally disposed in the cylinder 41. The head 43 is firmly disposed in the space 26 of the crook-confining member 21 to allow the crook-confining member 21 to rotate with the core 40 simultaneously. The keyhole 44 is defined in a lower portion of the cylinder 41. The tunnel 45 is defined in the head 43 for receiving the extension 13 of the indicator 10.

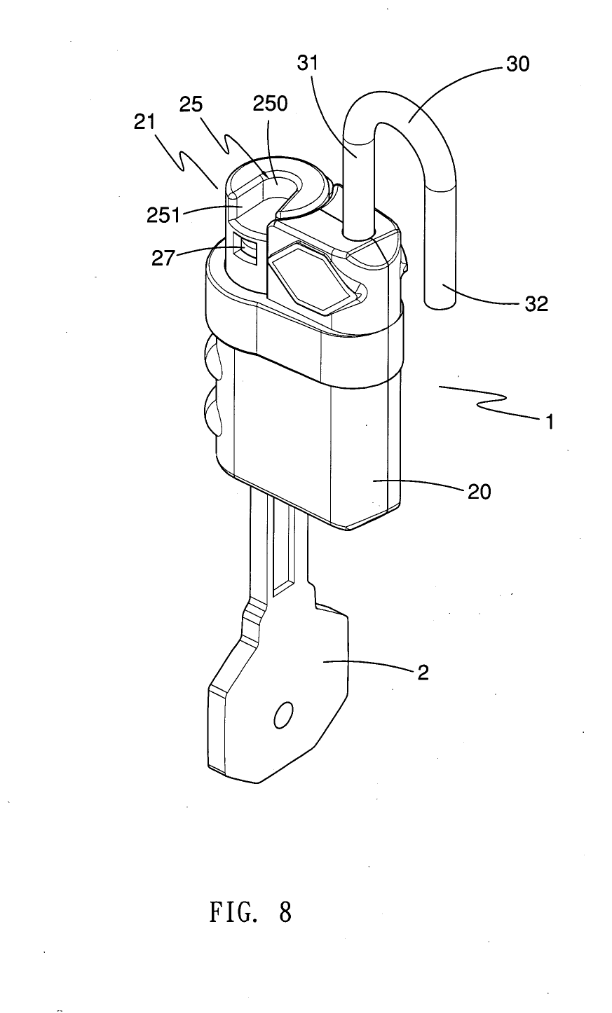

With reference to FIGS. 1 and 6 to 8, after the above-mentioned components are joined together, the head 43 of the core 40 is securely disposed in the space 26 and the indicator 10 is disposed in the compartment 23 of the crook-confining member 21, with the extension 13 inserted in the tunnel 45 of the core 40. Then, the resilient element 50 is mounted around the guide pole 230 and disposed in the recess 15. After inserted into the keyhole 44, the private key 2 can be turned, thus rotating the shaft 42. Because the head 43 is firmly disposed in the space 26, the crook-confining member 21 is rotated for confining or releasing the free end 32 of the crook 30.

The private key 2 is not long enough to reach the extension 13 of the indicator 10 so that the indicator 10 is located in the compartment 23 while the first zone 11 is exposed from the window 24. However, the general key 3 is long enough to reach and push the extension 13 upwards in the compartment 23 so that the second zone 12 is exposed from the window 24 to indicate that a person has used the general key 3 to activate the lock. When an unauthorized personnel tries to use an elongated tool to activate the lock, the elongated tool will also push the extension 13 to show the second zone 12 from the window 24 so that the owner of the lock can find out that an unidentified person has tampered with the lock.

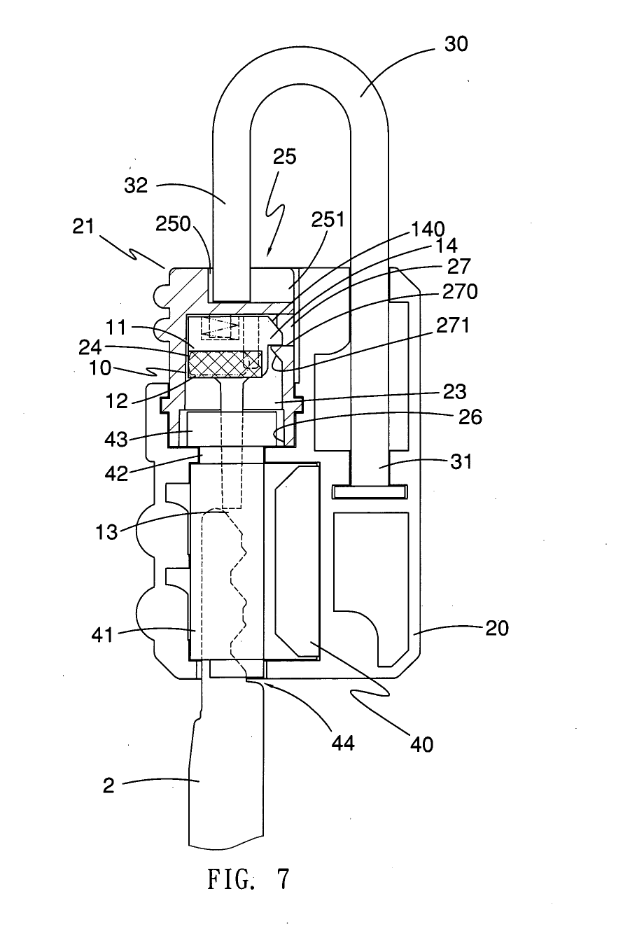

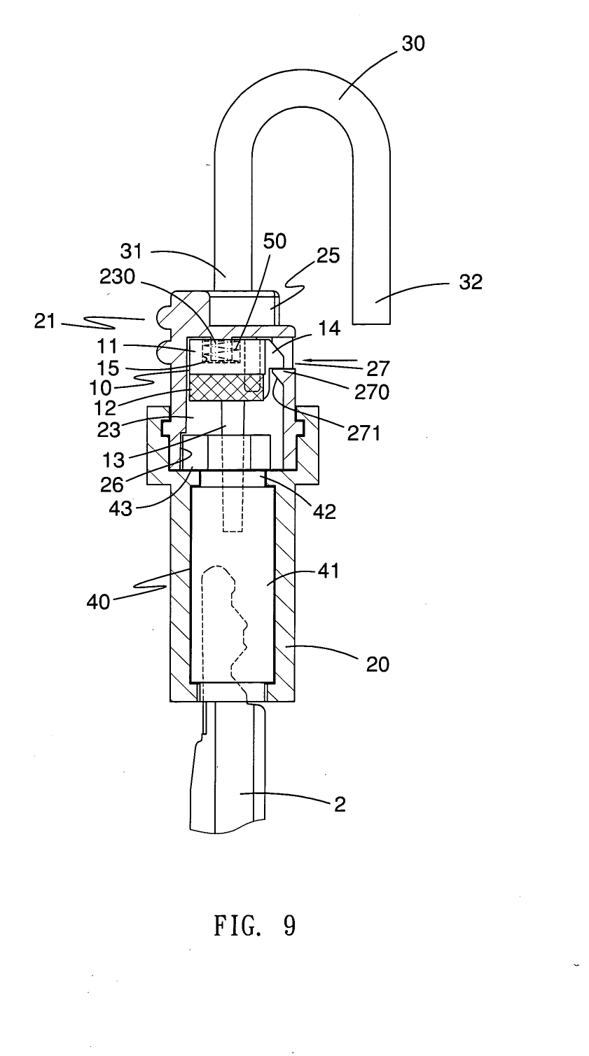

With reference to FIGS. 7, 9 and 10, after the general key 3 is inserted into the keyhole 44, the indicator 10 is pushed upwards within the crook-confining member 21 so that the second zone 12 is visible through the window 24. While the indicator 10 is moved upwards, the beveled face 140 of the clasp 14 that is stamped out of the external side of the indicator 10 is abutted by the beveled face 271 of the boss 270 to move closer to the first zone 11. After reaching the aperture 27, the clasp 14 springs into the aperture 27. During the upward movement of the indicator 10, the resilient element 50 is compressed to store a recoil force therein. To release the recoil force from the resilient element 50, a user may use a tool to push the clasp 14 back into the compartment 23. Then, the indicator 10 is forced to move back to its original position by the resilient element 50, where the first zone 11 is exposed from the window 24 again.

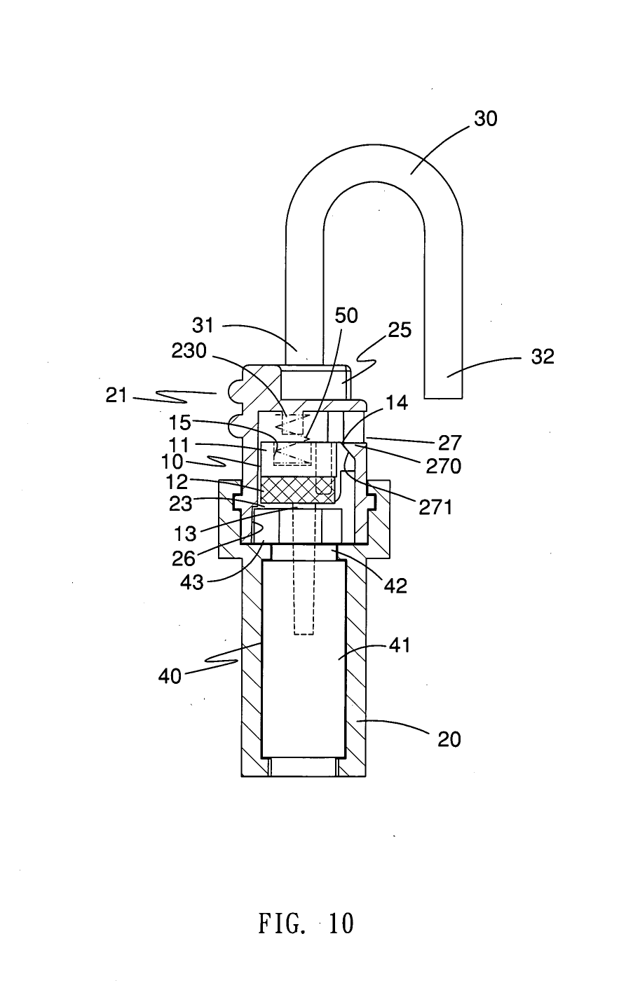

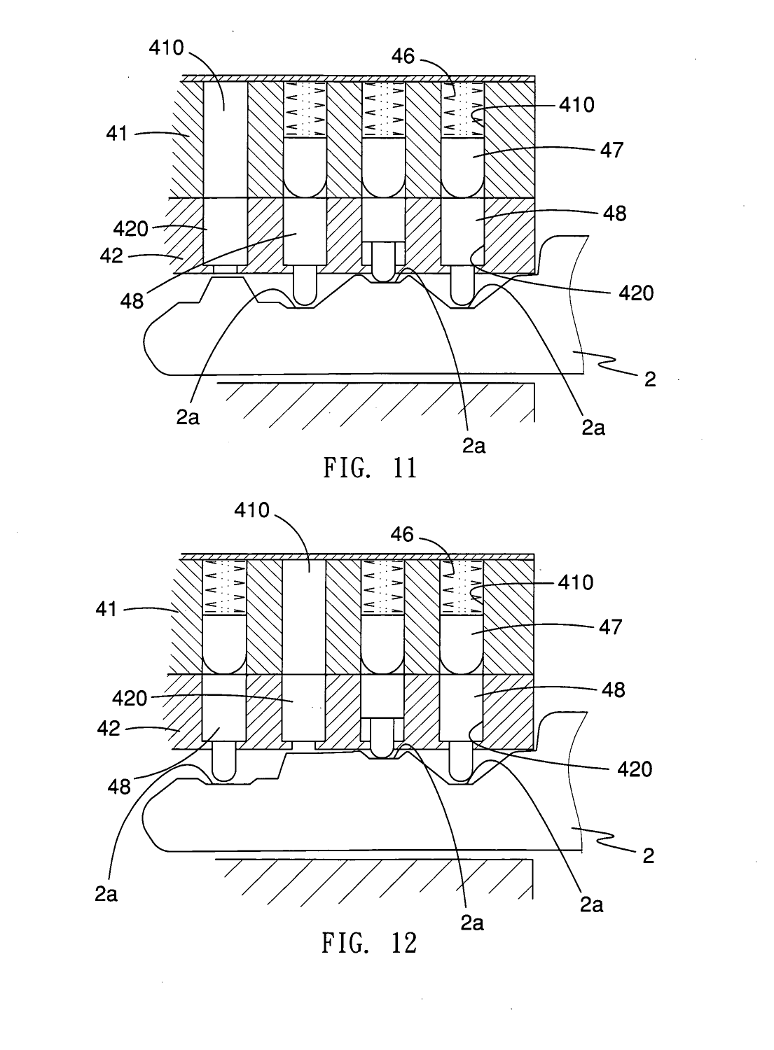

With reference to FIGS. 11 and 12, the cylinder 41 defines four slots 410 therein. The shaft 42 of the core 40 includes four slots 420 in communication with the slots 410. A spring 46 and a rod 47 are disposed in at least one of the slots 410. A rod 48 is disposed in at least one of the slots 420, corresponding to the rod 47.

Referring to FIG. 11, the slot 410 on the left does not contain any spring 46 or rod 47. The first slot 420 on the left does not contain any rod 48. The private key 2 includes indentations 2a along an edge thereof, corresponding to the rods 48 disposed in the remaining slots 420 so that the private key 20 can rotate the shaft 42. In the present invention, the spring 46, the rod 47 and the rod 48 are used as a controlling unit to control the rotation of the shaft 42.

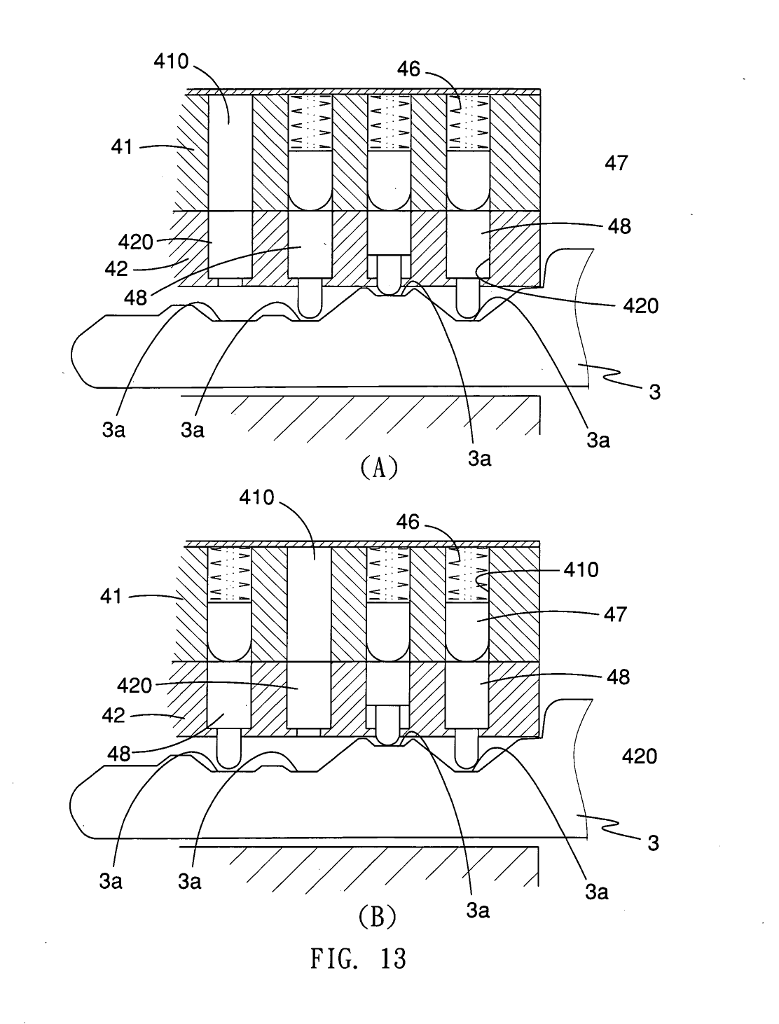

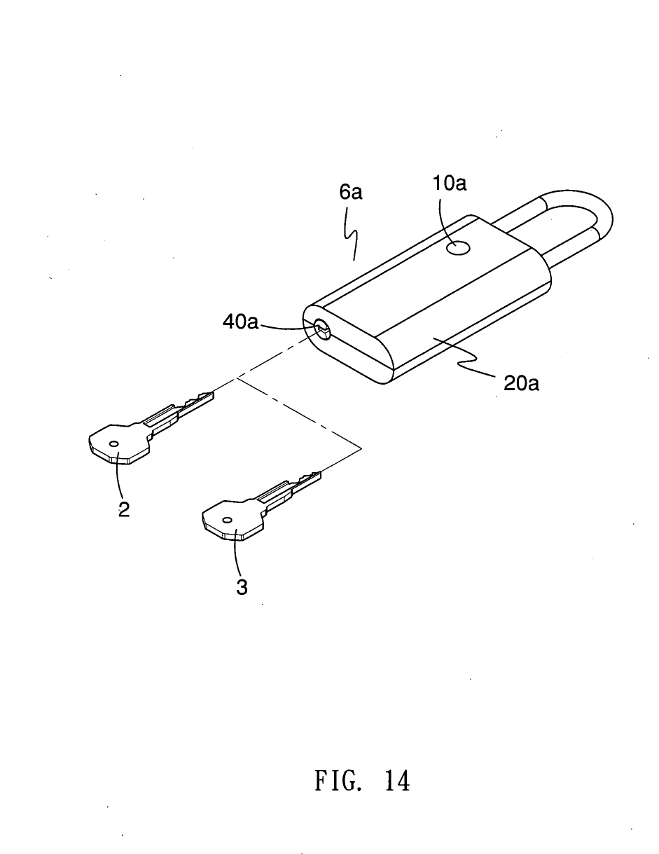

Referring to FIG. 13A, the general key 3 includes indentations 3a corresponding to the rods 48, which are disposed in the second, third and fourth ones of the slots 420. Thus, the general key 3 can rotate the shaft 42.

Alternatively, with reference to FIG. 12, the second one of the slots 410 does not contain any spring 46 or the rod 47. The second one of the slots 420 does not contain any rod 48. The private key 2 includes indentations 2a corresponding to the rods 48 disposed in the first, third and fourth ones of the slots 420 so that the private key 2 is able to rotate the shaft 42.

With reference to FIG. 13B, the second indentations 3a of the general key 3 are aligned with the rods 48 in the first, third and fourth ones of the slots 420. Thus, the general key 3 can rotate the shaft 42.

Whether the private key 2 or the general key 3 is used to activate the core 40, both the private key 2 and the general key 3 include indentations 2a and 3a aligned with the rods 48. The design of the core 40 depends on which slot 410 does not contain any spring 46 or rod 47 while the corresponding one of the slots 420 does not contain any rod 48. Therefore, there are multiple choices for the structure of the core 40. If an unidentified key with indentations not corresponding to the empty second slots, the unidentified key will push the rod 48 out of a wall of the shaft 42, which hinders the rotation of the shaft 42, so that the core 40 is not activated. A private key 2 can only be used to activate a specific core 40. However, the general key 30 is designed to push all of the rods 48 no matter how the rods 48 are located in the slots 420.

Although the foregoing embodiment shows that the shaft 42 of the core 40 includes four sets of slots 410 and four sets of slots 420, the quantity of the slots 410 and 420 is not limited. Similar designs of the shaft 42 may be easily used to only allow a private key 2 to activate a specific core 40 while the general key 30 can be used to activate various cores 40.

In use, the private key 2 is owned by a private user and the general key 3 is owned by the customs personnel. Therefore, when the second zone 12 is exposed from the window 24, the private user will be able to know that the lock of the present invention was opened by the customs personnel.

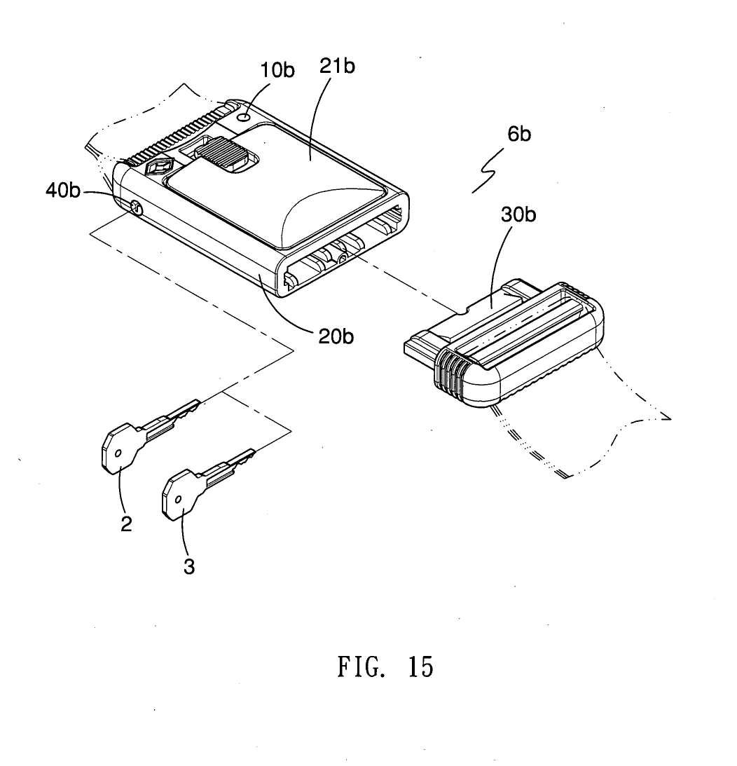

Referring to FIGS. 14 to 17, there are shown other embodiments of the present invention. For example, a lock 6a shown in FIG. 14 does not include the crook-confining member 20, but includes a core 40a and an indicator 10a within the casing 20a.

Although the lock 6b shown in FIG. 15 does not include the crook-confining member 21 and the crook 30, the plug 30b is substantially the same as the crook 30 and the socket 21b for connection to the plug 30b is substantially the same as that of the crook-confining member 21. In this embodiment, the lock 6b includes a core 40b and in indicator 10b disposed in the casing 20b.

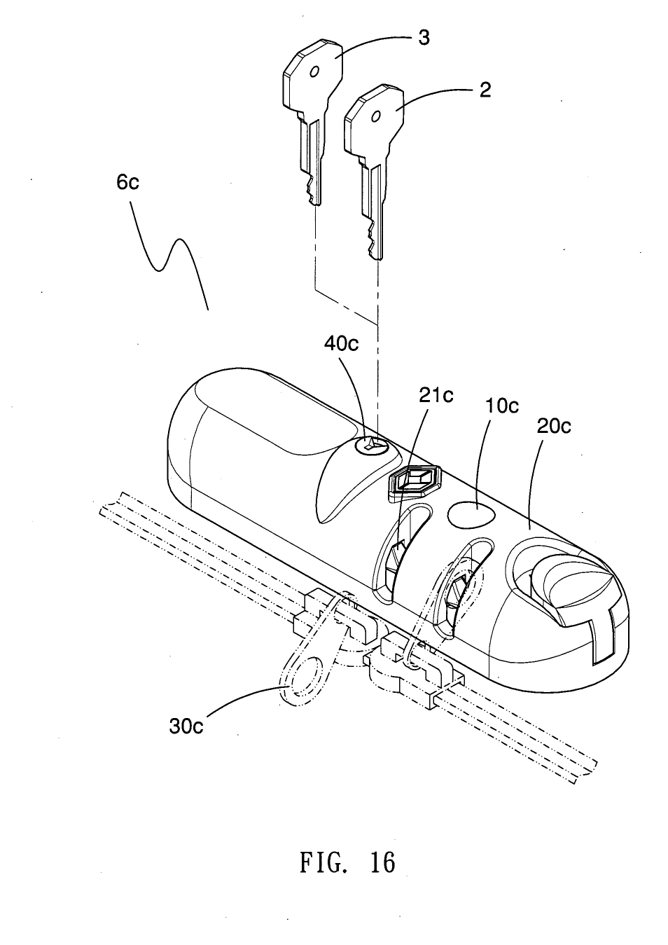

Although the lock 6c shown in FIG. 16 does not include the crook-confining member 21 and the crook 30, the tab 30c is substantially the same as the crook 30 and the clasping element 21c is substantially the same as the crook-confining member 21. In this embodiment, the lock 6c includes a core 40c and in indicator 10c disposed in a casing 20c.

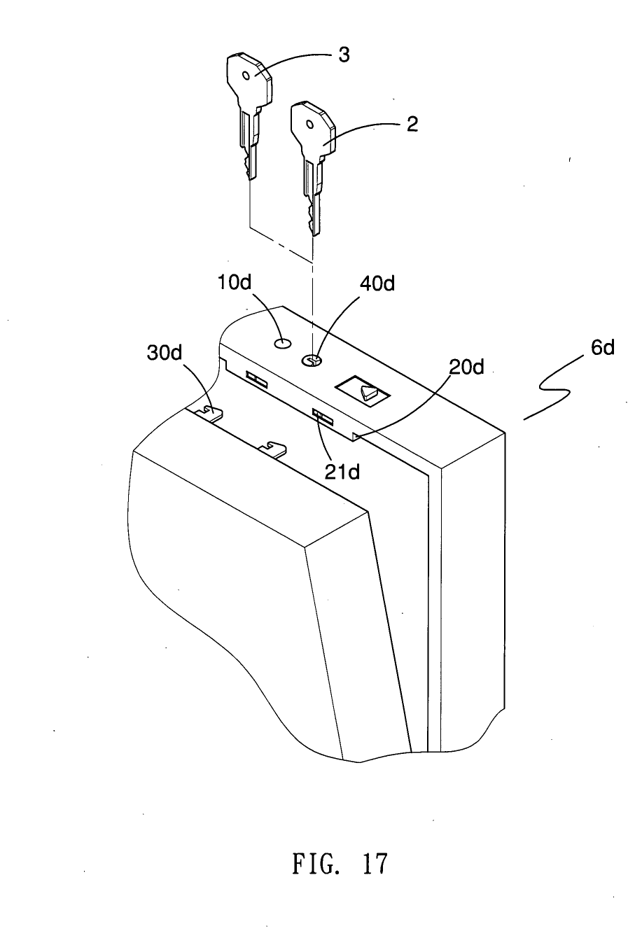

Although the lock 6d shown in FIG. 17 does not include the crook-confining member 21 and the crook 30, the hook 30d is substantially the same as the crook 30 and the clasping element 21d is substantially the same as the crook-confining member 21. In this embodiment, the lock 6d includes a core 40d and in indicator 10d disposed in a casing 20d.

It is to be understood, however, that even though numerous features and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A lock comprising:
a casing;
a core disposed in the casing and configured in such a way that a private key and a general key can be used to activate the core; and
an indicator disposed in the casing and movable from a first position to a second position by the general key and movable from the second position back to the first position by the private key.

2. The lock as claimed in claim 1 further comprising a crook comprising a root rotationally disposed in the casing and a free end extending out of the casing.

3. The lock as claimed in claim 2 further comprising a crook-confining member movably connected to the casing for confining the free end of the crook.

4. The lock as claimed in claim 3, wherein the crook-confining member is provided on the casing.

5. The lock as claimed in claim 3, wherein the indicator is movably connected to the crook-confining member.

6. The lock as claimed in claim 6, wherein the crook-confining member comprises a compartment for receiving the indicator and a window in communication with the compartment, and the indicator comprises an indication zone visible through the window when the indicator is in the second position.

7. The lock as claimed in claim 3, wherein the crook-confining member is provided with a recess to receive the free end of the crook.

8. The lock as claimed in claim 7, wherein the recess comprises a first opening defined in an upper face of the crook-confining member and a second opening defined in a lateral face of the crook-confining member to communicate with the first opening so that the free end of the crook is movable into the recess via the second opening.

9. The lock as claimed in claim 7, wherein the crook-confining member comprises an aperture in communication with the compartment so that when the private key is used to turn the core to the unlocking position, the aperture is opened to receive a tool used to return the indicator to the first position from the second position.

10. The lock as claimed in claim 3, wherein the crook-confining member is firmly connected to the core so that when the core is activated, the crook-confining member is moved in response to the rotatable movement of the core.

11. The lock as claimed in claim 8, wherein the core includes a keyhole for receiving the private key and the general key, and the indicator comprises an extension inserted into the keyhole so that when one of the general key and an elongated tool is inserted into the keyhole, the extension of the indicator is pushed so that the indicator is pushed from the first position to the second position.

12. A lock comprising:
a casing;
a core disposed in the casing and configured in such a way that a private key and a general key can be used to activate the core; and
an indicator disposed in the casing and movable from a first position to a second position outside the casing by the general key and movable from the second position back to the first position by the private key.

13. The lock as claimed in claim 12 further comprising a crook comprising a root rotationally disposed in the casing and a free end extending out of the casing.

14. The lock as claimed in claim 13 further comprising a crook-confining member movably connected to the casing for confining the free end of the crook.

15. The lock as claimed in claim 14, wherein the indicator is movably connected to the crook-confining member.

16. A pad lock defining an aperture in an external surface thereof and comprising:
a crook comprising a root rotationally disposed in the casing and a free end extending out of the casing;
a core disposed in the casing and configured in such a way that a private key and a general key can be used to operate the core to lock and unlock the free end of the crook; and
an indicator disposed in the casing and movable from a first position to a second position outside the casing by the general key and movable from the second position back to the first position by an insertion into the aperture of the casing.

17. The lock as claimed in claim 16 further comprising a crook comprising a root rotationally disposed in the casing and a free end extending out of the casing.

18. The lock as claimed in claim 17 further comprising a crook-confining member rotationally connected to the casing for confining the free end of the crook.
